(19) United States
(12) Patent Application Publication
(10) Pub. No.: US 2021/0154873 A1
(43) Pub. Date: May 27, 2021

(54) METHOD FOR CROSS-CUTTING A MATERIAL WEB MOVED ALONG A DIRECTION OF MOVEMENT AND DEVICE THEREFORE

(71) Applicant: ANDRITZ AG, Graz (AT)

(72) Inventors: Michael ORNIK, Empersdorf (AT); Jürgen GRONOSTAY, Graz (AT); Alois JAMMERNEGG, St. Martin (AT)

(73) Assignee: ANDRITZ AG, Graz (AT)

(21) Appl. No.: 16/632,807

(22) PCT Filed: Jul. 26, 2018
(86) PCT No.: PCT/AT2018/060165

§ 371 Date: Jan. 21, 2020

(30) Foreign Application Priority Data
Sep. 15, 2017 (AT) A 50777/2017

(51) Int. Cl. B26D 1/62; B26D 1/00; B26D 7/08; B26D 7/18

(52) U.S. Cl. CPC B26D 1/626; B26D 1/0006; B26D 2007/082; B26D 7/1818; B26D 2001/0066; B26D 7/08

(57) ABSTRACT

The invention relates to a method for cross-cutting a material web (1), in particular a pulp web or the like, that is moved in a direction of movement (2), wherein the material web (1) is moved through between two axes of rotation oriented approximately perpendicularly to the direction of movement (2), about which axes of rotation cooperating blades (3, 4) are moved with a rotary movement, said blades (3, 4) cutting the material web (1) approximately perpendicularly to the direction of movement (2) as said material web (1) passes through between the axes of rotation. In order to achieve a high-quality cut edge with little noise pollution and high system availability, the invention provides that, after the material web (1) has been cut, a force is applied to a part of the material web (1) that is carried along with a blade (3, 4) and in particular a part of the material web (1) that bears against a blade (3, 4), in order to separate the material web (1) from the rotary movement of the blade (3, 4). Furthermore, the invention relates to a device for cross-cutting a material web (1) that is moved in a direction of movement (2), having at least two cooperating blades (3, 4), which are rotatable about axes of rotation arranged approximately perpendicularly to the direction of movement (2), wherein the material web (1) is movable through between the axes of rotation, such that the material web (1) is able to be cut by the blades (3, 4) approximately transversely to the direction of movement (2).

The invention relates to a method for cross-cutting a material web moved along a direction of movement, in particular a pulp web or the Ike, wherein the material web is moved between two rotational axes oriented roughly perpendicular to the direction of movement, wherein cooperating blades are moved around these rotational axes with a rotational movement, cutting the material web roughly perpendicular to the direction of movement as it passes through between the rotational axes.

The invention further relates to a device for cross-cutting a material web moved along a direction of movement with at least two cooperating blades, which can be rotated around rotational axes arranged roughly perpendicular to the direction of movement, wherein the material web can be moved through between the rotational axes, so that the material web can be cut by the blades roughly transverse to the direction of movement.

Methods and devices of the kind mentioned at the outset have become known from prior art, for example for cutting continuously manufactured material, such as pulp, into sheets of identical length, Such devices are referred to as twin-screw cross-cutters, and have proven themselves in manufacturing high-quality cut edges. In addition, a longer service life is achieved for the blades in such devices than in devices where a first cutting edge is fixed in place and only a second cutting edge is moved. Furthermore, less noise and dust are generated.

In such a twin-screw cross-cutter, a pulp web is usually moved between cutting rollers, which rotate inversely and synchronously, so that the continuously moved material web is then cut transverse to the direction of movement once the blades arranged on the cutting rollers have reached an engaging position, which usually lies roughly on a line that connects the two rotational axes, and in which the blades are spaced minimally apart from each other. The length of a sheet of the material web cut away in the process thus depends on the speed of the material web in the direction of movement on the one hand, and on a circumferential speed of the cutting rollers and a number of blades or cutting edges arranged on the cutting rollers on the other.

In order to achieve as smooth a cut as possible and a high quality for the cut material, it is advantageous in inversely rotating cutting rollers that a speed of the blades in the engaged position roughly correspond to a speed of the material web along the direction of movement both in terms of direction and magnitude. As a consequence, a speed of the cutting rollers is essentially predetermined by a speed of the material web along the direction of movement, which is why a length of the sheets cut with a corresponding device is usually essentially defined by a diameter of the cutting rollers and a number or distance of the blades arranged on the cutting rollers.

When operating a corresponding system, for example a system for pulp manufacture, however, sheets of varying length have to be cut. Given a constant speed of the material web along the direction of movement, this can only be accomplished by simultaneously reducing a rotational speed of the cutting rollers, especially since the blades are as a rule fixedly arranged on the cutting rollers.

However, reducing the rotational speed in this way causes a speed of the blades in the engaged position to be less than a speed of the supplied material web along the direction of movement. It was found that, after a cut has been made or after the blades have run through the engaged position, the faster moving material web in the direction of movement is pressed against one of the slower moving blades, as a result of which a contact force acts between the material web and this blade, so that the material web is made to follow along the rotational direction of the blade at least for a short time by the contact force of the latter, and exits a prescribed ideal path along the direction of movement of the material web in front of the cutting rollers. This can lead to the material web causing a jam, making it necessary to interrupt a production process, for example to stop a system for manufacturing pulp.

This is where the invention comes in. The object of the invention is to indicate a method of the kind mentioned at the outset with which a moved material web can be cut into pieces of varying size, wherein a high quality of a cut edge is achieved on the one hand, and the risk of a jam being created is avoided on the other. In addition, a device for implementing such a method is to be indicated.

This object is achieved according to the invention by a method of the kind mentioned at the outset, in which, after the material web has been cut, a force is applied to a part of the material web that is carried along with a blade, in particular one that abuts against a blade, so as to detach the material web from the rotational movement of the blade.

It was recognized within the framework of the invention that sheets of varying size could be manufactured given a high reliability of the system if the material web that abuts against a blade or some other part moved with the cutting roller and presses against the blade or cutting roller is detached from the blade by an actively applied force. The applied force, which is usually directed at least partially in a direction from a rotational axis of the cutting roller from which the material web is detached toward the material web, or has a correspondingly oriented component, thus overcomes a contact force that acts between the material web and the cutting roller or the blade, and causes the material web to be at least partially carried along with the cutting roller.

In particular, this contact force can depend on a relative speed between the blade and material web, a stiffness of the material web and structural parameters or dimensions of the device, and as a general rule has one component in the direction of the direction of movement as well as a component perpendicular to the direction of movement, which is caused by friction between the material web and the blade, and leads to the material web being carried along with the cutting roller after a separation of the material web or a cut. The contact force acting on the material web is thus most often oriented against the direction of movement and toward the cutting roller, with the blade against which the material web abuts being connected with said cutting roller.

As a consequence, a force sufficient in terms of magnitude and direction for overcoming the force that carries along the material web given a specific device is readily derived for a specific system from tests and/or simulations, so that the method can easily be applied to a variety of devices. After a force has been applied according to the invention to detach the material web from the blade, the material web is thus released once again immediately after making the cut, thereby eliminating the risk of causing a jam.

The force can basically be applied in a variety of ways. An especially robust process arises by applying the force with a spring.

It is beneficial for the spring to be tensioned by a relative movement of the two blades during each rotation of the blades before the blades cut the material web. This eliminates the need for separately supplying energy for applying the force. In addition; having the spring be tensioned by a relative movement of the blades ensures that the spring is tensioned independently of a circumferential speed of the cutting roller at an angular position prior to making the cut, and that the force is applied immediately after making the cut.

Alternatively or additionally, it can be provided that the force be applied pneumatically. For example, this can be done with an air nozzle, a fillable air hose and/or a cylinder activated by air pressure.

Furthermore, it can be provided that the force be applied hydraulically. For example, a stamp that can traverse along a surface against which the material web abuts after cut, in particular on a rear surface of the blade, can be provided, which is activated with a hydraulic cylinder.

A corresponding apparatus, such as an air nozzle or a hydraulic cylinder, can here be arranged so as to corotate with the cutting roller, or even fixed in place in the device. If a corotating apparatus is used, it is as a rule set up to detach the material web from the cutting roller with which the apparatus corotates.

An easily implementable method is achieved by applying the force with an apparatus connected with the blade so as to corotate with it, with the portion of the material web being detached from this blade. The force is usually applied with an apparatus, in particular with a spring, which is designed to corotate with a cutting roller with is connected the blade from which the material web is to be detached after a cut. As a rule, this is a leading blade when the blades are spaced apart from each other along the direction of movement in an engaged position where the latter make a cut through the material web, so as to prevent the blades from contacting each other, and thus the cutting edges arranged on the blades from being blunted or damaged.

A method according to the invention is usually implemented by having the blades rotate inversely. The blades that cut the material web in the engaged position have a circumferential speed in the direction of a movement of the material web in the engaged position, so that a relative speed between the blades and the material web is as low as possible in the engaged position. Given a material web moved from left to right in a side view, an upper cutting roller arranged above the material web thus has a counterclockwise rotational direction, and a lower cutting roller arranged under the material web has a clockwise rotational direction.

In order to achieve a high-quality cut edge of the material web, it is beneficial when cutting sheets of varying length during the production of longer sheets that the circumferential speed of the blades be less than a speed of the material web along the direction of movement. During a normal operation in which a corresponding system is operated over a predominant portion of an operating period, manufactured sheets can be fabricated at a speed of the blades in the circumferential direction roughly corresponding to the speed of the material web in the direction of movement, and longer sheets can be fabricated during a special operation by reducing a rotational speed of the cutting rollers, without this increasing the risk of a jam-induced system failure.

The other object is achieved according to the invention by a device of the kind mentioned at the outset, which provides an apparatus with which a force can be applied to a part of the material web that is carried along with a blade, in particular one that abuts against a blade, so as to detach the material web moved along with the blade from the blade. The force can here be applied in any way, so as to detach the material web from a movement with the blade or from a movement of a cutting roller on which the blade is arranged. The applied force usually overcomes a frictional force, which acts between the material web and the rear surface of the blade. The force is normally at least partially directed radially to the rotational axis of the blade, and away from this rotational axis, with the material web being detached from said blade.

It is preferably provided that the apparatus have a spring, which is arranged in such a way that the spring is tensioned with the device operating as intended by a relative movement of the two blades, before the blades reach an engaged position in which the blades cut the material web. The spring is usually connected with the cutting roller of the corresponding blade in such a way that the spring can be tensioned in a radial direction. In order to tension the spring given a relative movement of the two blades before the blades reach the engaged position, in which the blades have a minimal distance and cut the material web, the spring in a radial direction is preferably positioned on the first corresponding cutting roller or connected with the corresponding, as a rule leading blade in such a way that the blade of the second cutting roller that normally carries the trailing blade presses the spring inwardly in a radial direction, so that it is tensioned before the blades reach the engaged position.

It is beneficial for the blades to be arranged in such a way that the blades are spaced apart from each other in the direction of movement in an engaged position, so that one blade comprises a leading blade, and one blade comprises a trailing blade. A distance in the direction of movement can here also measure less than 1 mm. This easily results in a cut edge with a high quality, while at the same time preventing the cutting edges of the blades from impacting each other during an engagement and damaging each other.

The apparatus is advantageously designed to apply a force to a part of the material web that is carried along with the leading blade. It has been shown that a correspondingly arranged material web usually abuts against the leading blade and is moved along with the latter, because the material web slides from an inclined rear surface of the trailing blade onto a rear surface of the leading blade. Therefore, it is advantageous that the apparatus be designed to apply a force to a part of the material web that is carried along with the leading blade, so as to detach the material web from the leading blade.

The material web is especially reliably detached from the blade if the leading blade has a roughly radially oriented rear surface. After making a cut, the material web then usually abuts against the radially oriented rear surface of the leading blade, and can be reliably detached from the latter with the apparatus. The leading blade thus normally has a roughly radially oriented rear surface along with a cutting angle of less than 90°, and hence an inclined front surface. However, the trailing blade has a front surface oriented roughly radially to the corresponding cutting roller and a rear surface arranged at a cutting angle of also less than 90° to the front surface, so that the material web can slide from the rear surface of the trailing blade to the rear surface of the leading blade.

In order to achieve an especially simple structural design, it is beneficial that the apparatus be arranged on a rear surface of the blade, in particular on a rear surface of the leading blade. The material web is then easily moved or pressed away from the rear surface of the leading blade in a radial direction if the apparatus is designed to apply a compressive force that acts at least partially in a radial direction.

It is beneficial for the blades to be arranged in such a way that the blades overlap each other in a radial direction in an engaged position. This ensures a reliable cut with a high-quality cut edge through the material web.

It is advantageous that the apparatus have a contact element that is connected with the blade in a radial direction via a spring, and in particular consists of a wear-resistant material. The material web can then be detached from a movement with the rotating blade via the spring with the wear-resistant material. The spring can further be tensioned via the wear-resistant material by the blade, which cooperates with the blade with which the apparatus is connected in a corotating manner. The wear-resistant material advantageously protrudes over the blade with which the apparatus rotates in a state where the spring is not tensioned. This ensures that the material web is completely detached from the blade when the spring is relaxed after the engagement point. For example, the wear-resistant material can consist of a cuboid made out of plastic, which is radially arranged on coil springs on a cutting roller in the rotational direction of the cutting roller directly on a rear surface of the blade, and preferably extends over a width of the cutting roller where the blade is positioned.

Alternatively or additionally, it can be provided that the apparatus have an electromechanically acting actuator. For example, an electromagnet can be provided for applying a force, so as to detach the material web from the blade. In this case, the actuator is normally activated after the blades have passed the engagement point, so as to detach the material web from the cutting roller or blade.

The apparatus can also be designed for pneumatic activation. For example, the apparatus can to this end have a nozzle, with which a compressed air is applied to detach the material web from a rotation along with the blade or from a movement of the blade.

The apparatus can also be designed for hydraulic activation. To this end, for example, a contact element connected by a hydraulic cylinder with the blade from which the material web is to be detached can be provided, so that the material web is detached from the blade via the hydraulic cylinder and contact element with a radially outward force.

One especially simple embodiment of the device is enabled by designing the apparatus so that it can be activated by a centrifugal force and/or gravitational force. To this end, the apparatus can have a radially movable element and be arranged on an upper cutting roller, which preferably has the leading blade, so that the centrifugal force and gravitational force acting on the radially movable element produces a radially outward or downward force, with which a material web abutting the blade is downwardly detached from the blade. In this case as well, the element is advantageously inwardly moved or tensioned by the second or trailing blade as the blades approach before the engaged position.

Examples of additional features, advantages and effects may be gleaned based on the following exemplary embodiments described below. The drawings to which reference is here made show:

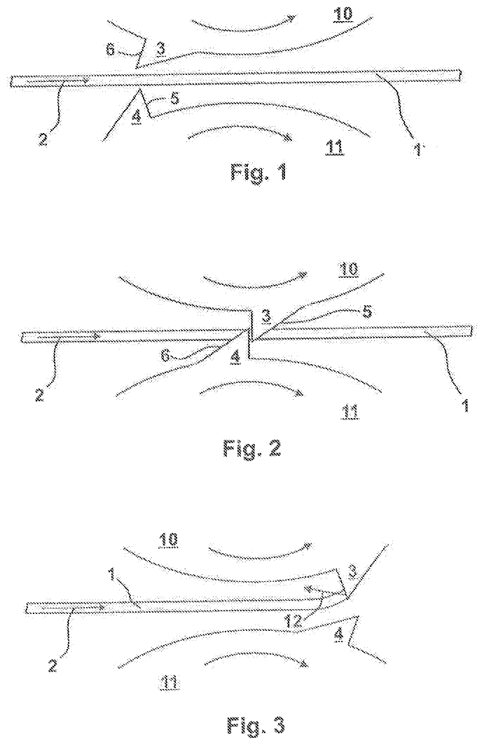

FIGS. 1 to 3 different procedural states of a method for cross-cutting a material web;

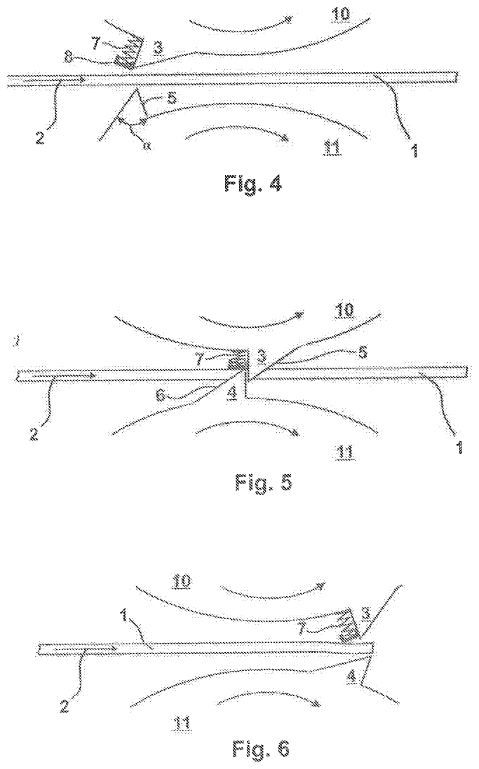

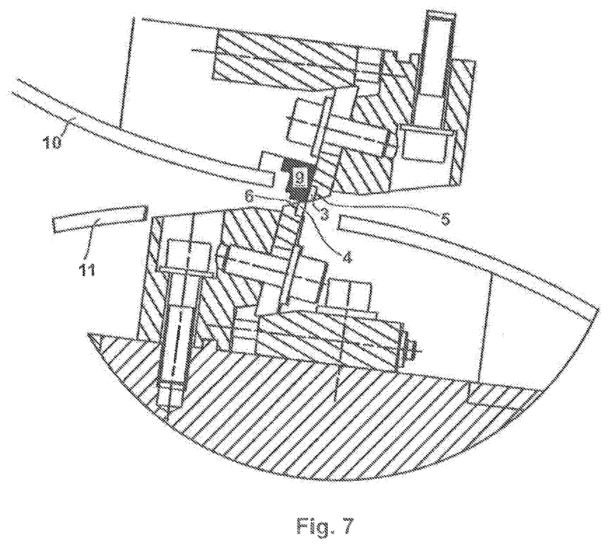

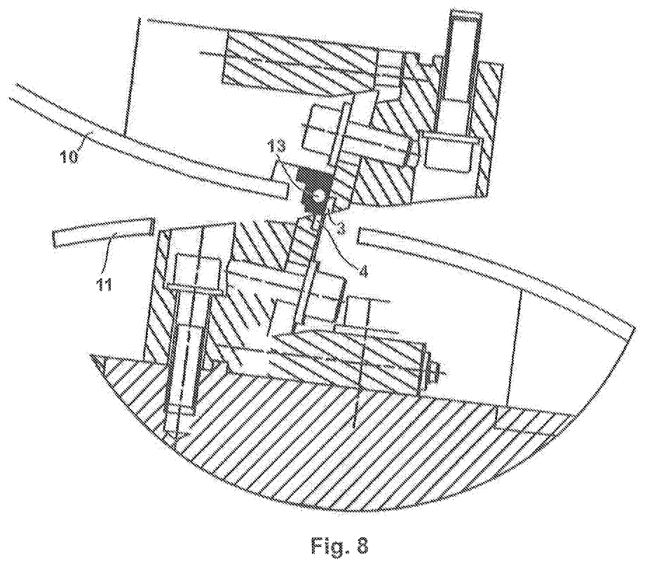

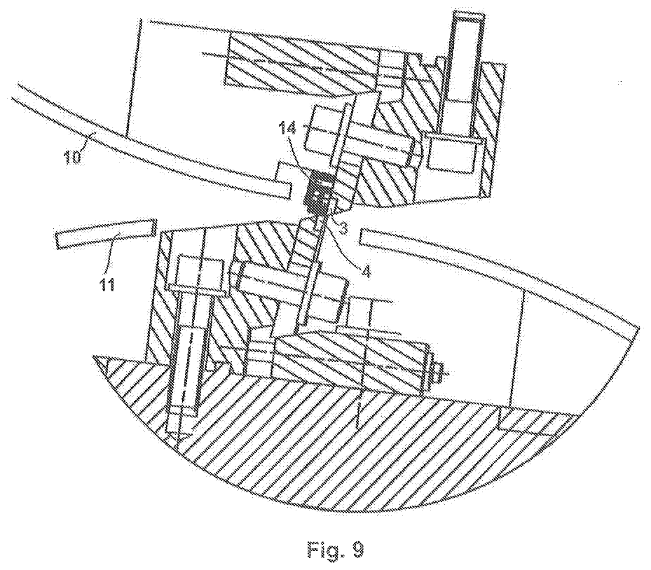

FIGS. 4 to 6 different procedural states of a method according to the invention for cross-cutting a material web;

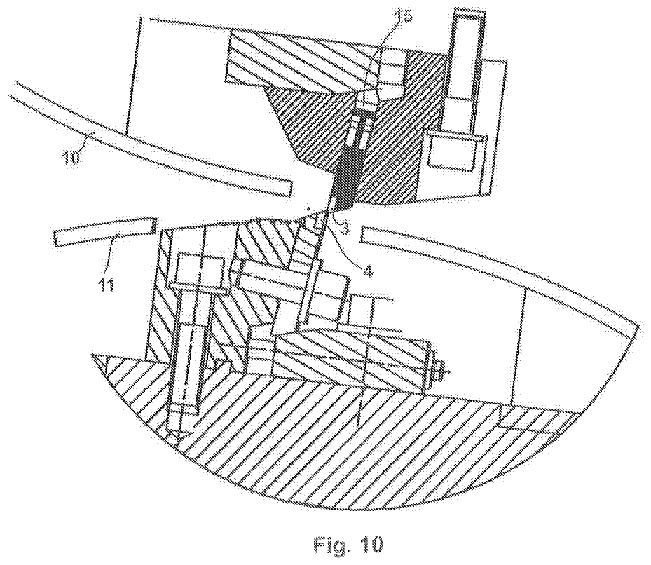

FIGS. 7 to 15 various devices according to the invention in detail.

FIGS. 1 to 3 each present schematic views of a section through part of a device for cross-cutting a moved material web, wherein FIG. 1 shows a point in time before a cross-cut, FIG. 2 shows an engaged position, in which a cross-cut or separation of the material web 1 takes place, and FIG. 3 shows a point in time after a cut.

As evident, two cooperating cutting edges formed by a respective one front surface 5 and one rear surface 6 of a blade 3, 4 are arranged on two cooperating cutting rollers 10, 11, which rotate inversely around rotational axes (not depicted) and in the engaged position shown on FIG. 2 cut or separate the material web 1 transverse to the direction of movement 2 of the material web 1. The roughly parallel rotational axes are arranged above and below or on either side of the material web 1, and on the figures are oriented perpendicular to a drawing plane, so that the material web 1 usually driven by conveying means like conveyor rollers is moved through between the rotational axes.

The blades 3, 4 of the cutting rollers 10, 11 are here arranged offset, so that the blade 3 of the counterclockwise rotating, upper rotating roller 10 on FIGS. 1 to 3 forms a leading blade 3, and the blade 4 of the clockwise rotating, lower cutting roller 11 forms a trailing blade 4. This prevents the cutting edges formed by a respective front surface 5 and rear surface 6 from becoming damaged by coming into contact with each other during a cut through the material web 1.

A method described on FIGS. 1 to 3 is used to cut a pliable material web, for example which can be designed as a pulp web, transverse to the direction of movement 2, meaning perpendicular to the drawing plane, wherein the circumferential speed of the blades 3, 4 around the rotational axes roughly corresponds to the speed of the material web 1 along the direction of movement 2.

When manufacturing sheets of varying length, the rotational speed of the cutting rollers 10, 11 is usually reduced in order to cut longer sheets. As a result, the speed of the material web 1 in the direction of moment 2 is higher than the speed of the blades 3, 4 in the circumferential direction, which is why the material web 1, after making a cross-cut, slides over the inclined, rear surface 6 of the trailing blade 4 onto the rear surface 6 of the leading blade 3 oriented radially to the upper cutting roller 10, and subsequently abuts against the rear surface 6 of the leading blade 3, Because the speed of the material web 1 or the conveying means with which the material web 1 is driven before reaching the cutting rollers 10, 11 is higher by comparison with the speed of the blades 3, 4, the material web 1 is here pressed against the rear surface 6 of the leading blade 3, and owing to the resultant contact force 12 between the material web 1 and leading blade 3 can be moved along with this leading blade 3 as evident on FIG. 3. As a result, the material web 1 can become bent or curried, and a jam can form, making it necessary to stop the production process. As depicted, the contact force 12 acting on the material web 1 is oriented opposite the direction of movement 2 and toward the upper cutting roller 10.

In order to prevent the material web 1 from moving along with the leading blade 3 or to detach the material web 1 from the leading blade 3, the invention provides an apparatus, which is used to expose the material web 1 to a force, which detaches the material web 1 from the leading blade 3.

FIGS. 4 to 6 present a schematic view of a device according to the invention along with various states of a method according to the invention. As evident, the apparatus is here arranged on a rear surface 6 of the leading blade 3, and comprises a spring here exemplarily formed by a coil spring 7, which as the cutting rollers 10, 11 rotate is radially inwardly tensioned by a relative movement of the blades 3, 4. After the cutting rollers 10, 11 have reached the engagement point depicted on FIG. 5, the distance between the blades 3, 4 again increases, so that the coil spring 7 can be relaxed. The material web 1 is here pressed away from the rear surface 6 of the leading blade 3 by means of the coil spring 7 via a contact element 8 connected with the coil spring 7, and can thus continue to freely move along an ideal path after the cutting rollers 10, 11, which runs roughly in the direction of movement 2. The contact element 8 that presses the coil spring 7 onto the material web 1 and with the trailing blade 4 applies a force for tensioning the coil spring 7 usually consists of a wear-resistant material, preferably a wear-resistant plastic. Since the device according to the invention can also be used in wide pulp webs measuring several meters, several coil springs 7 can of course be arranged over the width of the device, i.e., perpendicular to the drawing plane and parallel to the rotational axis, so as to correspondingly spring load a contact element 8 designed with a corresponding length, so that a force can be applied over the entire width for detaching the material web 1.

After a cut, the material web 1 thus slides transverse to the direction of movement 2 through the rear surface 6 of the trailing blade 4 arranged at an angle a of less than 90° to the front surface 5 of the trailing blade 4 onto the roughly radially oriented rear surface 6 of the leading blade 3, from which the material web 1 is pressed radially outward with the apparatus, and thereby detached.

The apparatus can basically be designed in a variety of ways. FIG. 7 presents an exemplary embodiment of a device according to the invention, in which the apparatus has a spring formed by an elastic element 9. The elastic element 9 is here compressed up to the engagement point by the trailing blade 4 as the cutting rollers 10, 11 rotate, and relaxed after the engagement point, so as to apply a radial force to the material web 1 abutting against the rear surface 6 of the leading blade 3, and detach the material web 1 from the leading blade 3.

FIG. 8 shows another embodiment of the invention, wherein the apparatus has a hose 13 that can be filled with air. In this embodiment of the invention, the hose 13 is filled with air, so that the latter forms a spring, which is tensioned before an engaged position is reached by a cooperation between the two blades 3, 4 or a cooperation between the two cutting rollers 10, 11, and which detaches the material web 1 from the leading blade 3 after the engaged position has been reached.

FIG. 9 shows another embodiment of the invention. According to this embodiment, the apparatus has a hydraulic element 14, which can be designed to be actively activated or to be tensioned via the trailing blade 4, so as to apply a force to the material web 1 in a radial direction upon reaching the engaged position, and detach the latter from the leading blade 3.

FIG. 10 shows another embodiment of the invention. According to this embodiment, an actively activatable blade holder 15 is provided on the leading blade 3. A force for detaching the material web 1 from the leading blade 3 is thus applied upon activation of the blade holder 15 while retracting the leading blade 3 after the engaged position over a trailing part of the upper cutting roller 10, so that the material web 1 is detached from the leading blade 3 by the trailing part of the upper cutting roller 10.

FIG. 11 shows another embodiment of the invention, in which the apparatus has an elastic cover plate 18. The elastic cover plate 16 is tensioned or moved radially inward by a cooperation between the two cutting rollers 10, 11 before the engaged position is reached, and relaxed after the engaged position has been reached, so that the elastic cover plate 16 applies a radially outward force to the material web 1 as viewed from the upper cutting roller 10 that carries the leading blade 3, and the material web 1 is pressed away from the rear surface 6 of the leading blade 3.

FIG. 12 shows another embodiment of the invention, in which the apparatus has a nozzle 17 connected with a compressed air line 18, through which compressed air can be applied to the material web 1 after the engaged position has been reached. In a device designed in such a way, the material web 1 is thus detached from the leading blade 3 by compressed air.

FIG. 13 shows another embodiment of the invention, in which the apparatus comprises an element 19 which can be moved radially relative to the upper cutting roller 10 that carries the leading blade 3, and is moved radially outward after the engaged position by centrifugal force and gravitational force, so as to press the material web 1 away from the leading glade 3.

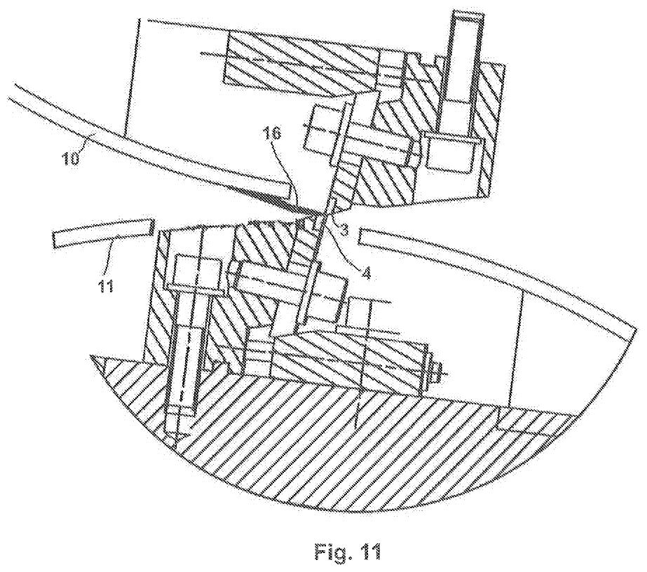

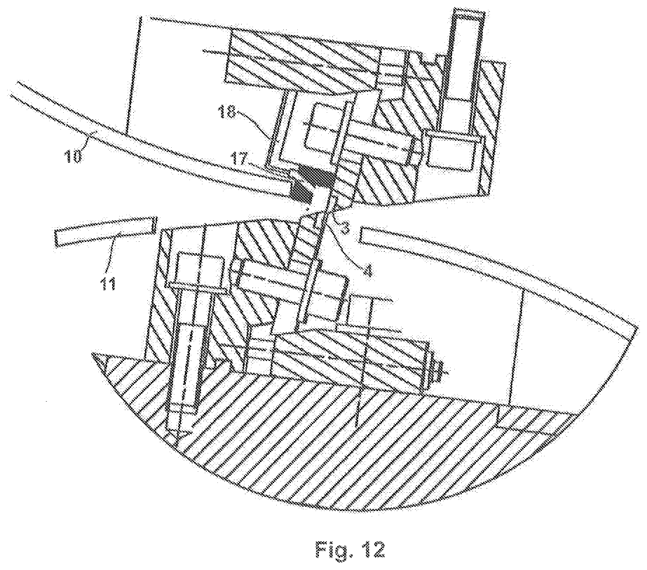

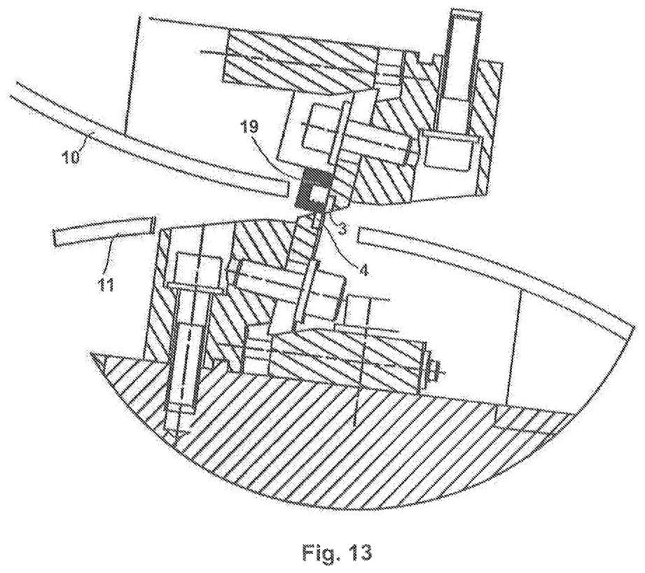

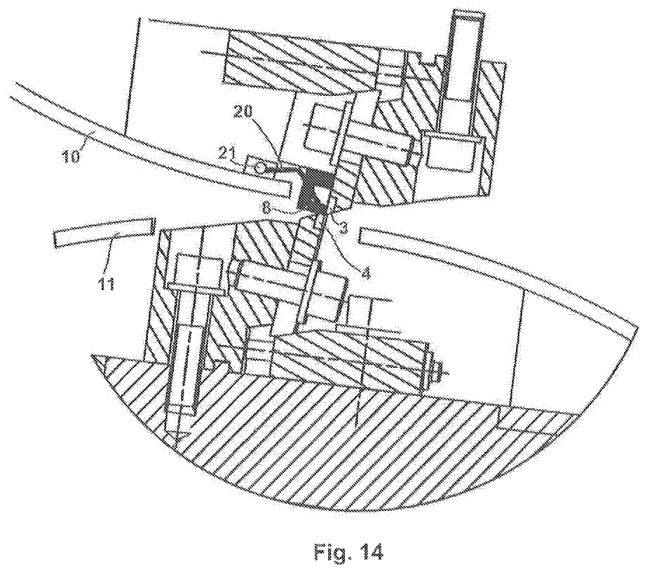

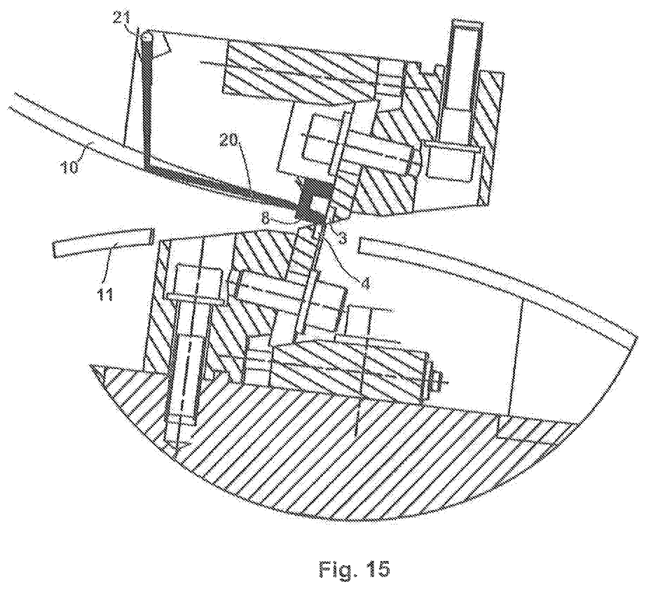

FIGS. 14 and 15 show other embodiments of the invention, in which the apparatus has a respective mechanical lever 20 mounted in the upper cutting roller 10 so that it can be rotates around a lever axis 21 for applying a force via a contact element B. As evident in the exemplary embodiments on FIGS. 14 and 15, the lever 20 can here have a varying length, so as to apply an outward radial force to the material web 1 and detach the latter from the blade.

Even though the respective apparatus in the depicted exemplary embodiments is arranged on the upper cutting roller 10, it goes without saying that it can also be positioned on the lower cutting roller 11 so as to detach the material web 1.

A method according to the invention makes it possible to cross-cut a material web 1 to varying lengths, in particular during pulp production, resulting in an advantageously smooth cut on the one hand, and a minimal risk of a jam along with a low noise generation on the other. Detaching the material web 1 from the blade 3 with an applied force reliably prevents a jamming of the material web 1, and thus a blockade of an entire system. As a consequence, the method and the device according to the invention are also suitable for wide material webs 1 with a speed in the direction of movement 2 exceeding 100 m/min. This also makes it possible to easily use a twin-screw cross-cutter for varying sheet lengths.

1. A method for cross-cutting a material web moved along a direction of movement, in particular a pulp web or the like, wherein the material web is moved between two rotational axes oriented roughly perpendicular to the direction of movement, wherein cooperating blades are moved around these rotational axes with a rotational movement, cutting the material web roughly perpendicular to the direction of movement as it passes through between the rotational axes, wherein, after the material web has been cut, a force is applied to a part of the material web that is carried along with a blade, in particular one that abuts against a blade, so as to detach the material web from the rotational movement of the blade, wherein the circumferential speed of the blades is less than the speed the material web along the direction of movement.

2. The method according to claim 1, wherein the force is applied with a spring.

3. The method according to claim 2, wherein the spring is tensioned by a relative movement of the two blades during each rotation of the blades before the blades cut the material web.

4. The method according to claim 1, wherein the force is pneumatically applied.

5. The method according to claim 1, wherein the force is hydraulically applied.

6. The method according to claim 1, wherein the force is applied with an apparatus connected with the blade in a corotating manner, with the part of the material web being detached from said blade.

7. The method according to claim 1, wherein the blades rotate inversely.

8. (canceled)

9. A device for cross-cutting a material web moved along a direction of movement in a method according to claim 1, with at least two cooperating blades, which can be rotated around rotational axes arranged roughly perpendicular to the direction of movement, wherein the material web can be moved through between the rotational axes, so that the material web can be out by the blades roughly transverse to the direction of movement, wherein an apparatus is provided with which a force can be applied to a part of the material web that is carried along with a blade, in particular one that abuts against a blade, so as to detach the material web moved along with the blade from the blade.

10. The device according to claim 9, wherein the apparatus has a spring, which is arranged in such a way that the spring is tensioned with the device operating as intended by a relative movement of the two blades, before the blades reach an engaged position in which the blades cut the material web.

11. The device according to claim 9, wherein the blades are arranged in such a way that the blades are spaced apart from each other in the direction of movement in an engaged position, so that one blade comprises a leading blade, and one blade comprises a trailing blade.

12. The device according to claim 11, wherein the apparatus is designed to apply a force to a part of the material web that is carried along with the leading blade.

13. The device according to claim 11, wherein, the leading blade has a roughly radially oriented rear surface.

14. The device according to claim 9, wherein the apparatus is arranged on a rear surface of the blade.

15. The device according to claim 9, wherein the blades are arranged in such a way that the blades overlap each other in a radial direction in an engaged position.

16. The device according to claim 9, wherein the apparatus has a contact element that is connected with the blade in a radial direction via a spring, and in particular consists of a wear-resistant material.

17. The device according to claim 9, wherein the apparatus has an electromechanically acting actuator.

18. The device according to claim 9, wherein, the apparatus is designed for pneumatic activation.

19. The device according to claim 9, wherein the apparatus is designed for hydraulic activation.
